(19) United States
(12) Patent Application Publication
(10) Pub. No.: US 2009/0276849 A1
(43) Pub. Date: Nov. 5, 2009

(54) INTELLECTUAL PROPERTY MANAGING SYSTEM, INTELLECTUAL PROPERTY MANAGING METHOD, AND PROGRAM FOR THE SAME

(75) Inventors: Masahiro Otomo, Tokyo (JP); Rieko Tomita, Tokyo (JP); Keishi Higashi, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: KABUSHIKI KAISHA TOSHIBA, MINATO-KU (JP); TOSHIBA SOLUTIONS CORPORATION, MINATO-KU (JP)

(21) Appl. No.: 12/306,081

(22) PCT Filed: Jun. 20, 2007
(86) PCT No.: PCT/JP2007/000654

§ 371 Date: Dec. 22, 2008

(30) Foreign Application Priority Data
Jun. 22, 2006 (JP) 2006-172204

(51) Int. Cl. G06F 9/46; H04L 9/32; G06F 21/00; G06F 15/16; G06Q 10/00; G06Q 50/00

(52) U.S. Cl. 726/19; 718/102; 709/206; 705/8

(57) ABSTRACT

It is made possible to share information on intellectual properties between enterprises and between an enterprise and an office, and system development efficiency and maintenance efficiency are improved. An intellectual property managing system includes: a database 50 in which common information on intellectual properties and individual information are stored, the common information being exchanged among applicant enterprises B, C, an office A, and a procedure-object organization, and the individual information being managed individually by the office A, the enterprises B, C, and the procedure-object organization; a common engine 10 which executes relevant job processing in response to a job execution demand issued from an office-oriented WBL 13a, by reading relevant information from the database 50 and notifies a result of the processing to the demander while reflecting the information changed as a result of the processing, in the common information and the individual information in the database, according to correspondence information in a data synchronization master 57.

### TECHNICAL FIELD

The present invention relates to an intellectual property managing system which manages information on intellectual properties such as patents, utility models, designs, and trademarks by a computer, and to an intellectual property managing method and a program for the same.

### BACKGROUND ART

In recent years, availability of an intellectual property managing system for performing the management of terms for the filing, examination requests, intermediate processing, and the like of domestic and foreign patents, utility models, designs, trademarks, and the like, the management of annual. fees after the registration, and so on has been increasing.

The intellectual property managing system is employed in, for example, patent attorney offices, enterprises requesting patent attorney offices to file their patent applications, and the like.

In patent attorney offices, enterprises, and the like, pieces of information of their own are stored in an intellectual property managing system, and they transmit/receive the information to/from each other when necessary.

For example, for the patent attorney offices, the information of the enterprises is clients, and for the enterprises, the patent attorney offices are those receiving the requests, and though a user interface such as a management window and a correspondence manner in a database differ between the both sides, the patent attorney offices manage case numbers of the clients and their own management numbers assigned by themselves in a corresponding manner.

In the enterprises, their own proposal numbers and the management numbers of the offices are also managed in a corresponding manner, and therefore, in view of a correspondence relation between the proposal number and the management number, data structure itself is often the same, though management item names are different.

Further, as the network environment such as the Internet is more improved, there have been proposed systems which, as application service providers (hereinafter referred to as “ASP”) on the Internet, provide intellectual property management service to a plurality of clients via the Internet (see, for example, JP-A 2002-073838 (KOKAI)).
Patent Reference 1: JP-A 2002-073838 (KOKAI)

### DISCLOSURE OF THE INVENTION

When enterprises and patent attorney offices use the ASP service or the like, the enterprises and the offices independently hold information on intellectual properties of their own even when they use the same ASP service, and therefore the information is not, as a rule, shared between the enterprises or between the office and the enterprise.

Even when information is shared between the enterprises, restriction is set so that applications for processing the information are operated only by predetermined fixed enterprises and only on the same business logic, and at present, it is not possible to realize the sharing of information regarding, for example, patent applications or the like when enterprises sharing the information change such as when a co-applicant differs depending on each case.

ASP service providers have been facing a problem of being burdened with a great system development load since they have to prepare programs individually for enterprises and offices because the enterprises and the offices have come to have an increasing need for GUI and application functions uniquely designed for themselves.

Further, when law amendment or the like is made or when the contents the service change, the ASP service provider has to readjust the whole system (software and hardware) by a maintenance work, which results in a drastic increase in load to maintenance workers. There is a need for a mechanism capable of solving these two problems at the same time.

The present invention was made to solve such problems, and its object is to provide an intellectual property managing system, an intellectual property managing method, and a program therefor which enable sharing of information on intellectual properties between enterprises and between an enterprise and an office and realize improved system development efficiency and maintenance efficiency.

To solve the aforesaid problems, an intellectual property managing system of the present invention includes: a database in which common information on intellectual properties and individual information are stored, the common information being exchanged between at least two of a procedure-object organization, an enterprise, and an office, and the individual information being managed individually by the procedure-object organization, the enterprise, and the office; a data synchronization raster in which correspondence information is stored, the correspondence information being used in converting each item of pieces of the individual information, which are managed in the database separately on per enterprise basis, office basis, and procedure-object organization basis, into another; job processing demanding units provided for the office, the enterprise, and the procedure-object organization respectively and issuing a demand in response to an instruction from a user; and a job processing executing unit which executes relevant processing in response to the demand issued from any of the job processing demanding units, by reading relevant information from the database, and notifies a result of the processing to the demander while reflecting the information changed as a result of the processing, in the common information and the individual information in the database according to the correspondence information in the data synchronization master.

An intellectual property managing system of the present invention is an intellectual property managing system in which a client computer of a delivery origin, a client computer of a delivery destination, and a server computer are connected to a network and the server computer transfers and delivers a delivery file transmitted from the client computer of the delivery origin to the client computer of the delivery destination, wherein the server computer includes a delivery manager which, after the delivery file received from the client computer of the delivery origin is delivered to the client computer of the delivery destination, monitors an opening state of the delivery file, and when the delivered file is opened in the client computer of the delivery destination within a predetermined period, automatically issues an electronic mail notifying that the delivery file is opened, to a pre-registered electronic mail address of the delivery origin, and when the predetermined period has passed, automatically issues a reminding electronic mail which urges to open the delivery file, to a pre-registered electronic mail address of the delivery destination.

An intellectual property managing method of the present invention includes: issuing, by any of job processing demanding units provided for an office, an enterprise, and a procedure-object organization respectively, a demand to a job processing executing unit in response to an instruction from a user; executing, by the job processing executing unit, relevant processing in response to the demand issued from any of the job processing demanding units, by reading relevant information from a database in which common information on intellectual properties and individual information are stored, the common information being exchanged between at least two of the procedure-object organization, the enterprise, and the office, and the individual information being managed individually by the procedure-object organization, the enterprise, and the office; and notifying, by the job processing executing unit, a result of the processing to the demander while reflecting the information changed as a result of the execution of the processing, in the common information and the individual information in the database according to correspondence information in a data synchronization master in which the correspondence information is stored, the correspondence information being used in converting each item of pieces of the individual information, which are managed in the database separately on per enterprise basis, office basis, and procedure-object organization basis, into another.

A program of the present invention is a program causing a computer to function as an intellectual property managing system managing intellectual properties, the program causing the computer to function as: a database in which common information on the intellectual properties and individual information are stored, the common information being exchanged between at least two of a procedure-object organization, an enterprise, and an office, and the individual information being managed individually by the procedure-object organization, the enterprise, and the office; a data synchronization master in which correspondence information is stored, the correspondence information being used in converting each item of pieces of the individual information, which are managed in the database separately on per enterprise basis, office basis, and procedure-object organization basis, into another; job processing demanding units provided for the office, the enterprise, and the procedure-object organization respectively and issuing a demand in response to an instruction from a user; and a job processing executing unit which executes relevant processing in response to the demand issued from any of the job processing demanding units, by reading relevant information from the database, and notifies a result of the processing to the demander while reflecting the information changed as a result of the processing, in the common information and the individual information in the database according to the correspondence information in the data synchronization master.

In the present invention, when the job processing demanding unit issues the demand to the job processing executing unit in response to the user's instruction, the job processing executing unit executes the relevant processing in response to the demand by reading the relevant information from the database, and notifies the result of the processing to the demander while reflecting the information changed as a result of the executed processing, in the common information and the individual information in the database according to the correspondence information in the data synchronization master.

In this manner, regarding data in which a change is made according to an instruction from a certain office, synchronization is realized in each item of the individual information of involved enterprises, which makes it possible to share information between different enterprises and offices.

Further, since the job functions are separated on per processing basis, system development in a unit of each separated job function is possible.

Further, when there arises a need for changing the system, the change may be made in a unit of each separated job function, which enables localization of a system maintenance work.

According to the present invention, it is possible to share information on intellectual properties among enterprises and offices, which realizes improved system development efficiency and maintenance efficiency.

### BRIEF DESCRIPTION OF DRAWINGS

FIG. 1 is a diagram showing the configuration of an intellectual property managing system of one embodiment of the present invention.

FIG. 2 is a view showing a database of the intellectual property managing system.

FIG. 3 is view showing an office A individual information DB.

FIG. 4 is a view showing an enterprise B individual information DB.

FIG. 5 is a view showing an enterprise C individual information DB.

FIG. 6 is a view showing a legal term master.

FIG. 7 is a view showing a work time limit master.

FIG. 8 is a view showing a data synchronization master.

FIG. 9 is a flowchart showing an operation example of the intellectual property managing system.

FIG. 10 is a view showing an examination request necessity reply request window.

FIG. 11 is a view showing a processing result window.

FIG. 12 is a view showing an example of the contents of a mail.

FIG. 13 is a flowchart showing another operation example of the intellectual property managing system.

FIG. 14 is a view showing an examination request necessity reply request window.

FIG. 15 is a view showing a processing result window.

FIG. 16 is a view showing a request mail transmission window.

FIG. 17 is a diagram showing the configuration of a system of an in-house+ASP type as another embodiment.

FIG. 18 is a diagram showing the configuration of an in-house type system as still another embodiment.

### EXPLANATION OF NUMERALS

1 . . . server computer, 10 . . . common engine, 11, 12, 13 . . . application software, 11a, 12a, 13a . . . workflow business logic (WBL), 11b, 12b, 13b . . . graphic user interface (GUI), 15 . . . data control unit, 16 . . . access controller, 17 . . . data synchronization controller, 18 . . . exclusive controller, 19 . . . file wrapper manager, 20 . . . data processing unit, 21 . . . numbering unit, 22 . . . derivation unit, 30 . . . data managing unit, 31 . . . case manager, 32 . . . time limit manager, 40 . . . data output unit, 41 . . . report output unit, 42 . . . general-purpose search unit, 50 . . . database, 55 . . . legal term master, 56 . . . work time limit master, 57 . . . data synchronization master, 60 . . . delivery file, 72, 82, 92 . . . client computer, 14, 71, 81, 91 . . . communication unit

### BEST MODE FOR CARRYING OUT THE INVENTION

Hereinafter, embodiments of the present invention will be described with reference to the drawings.

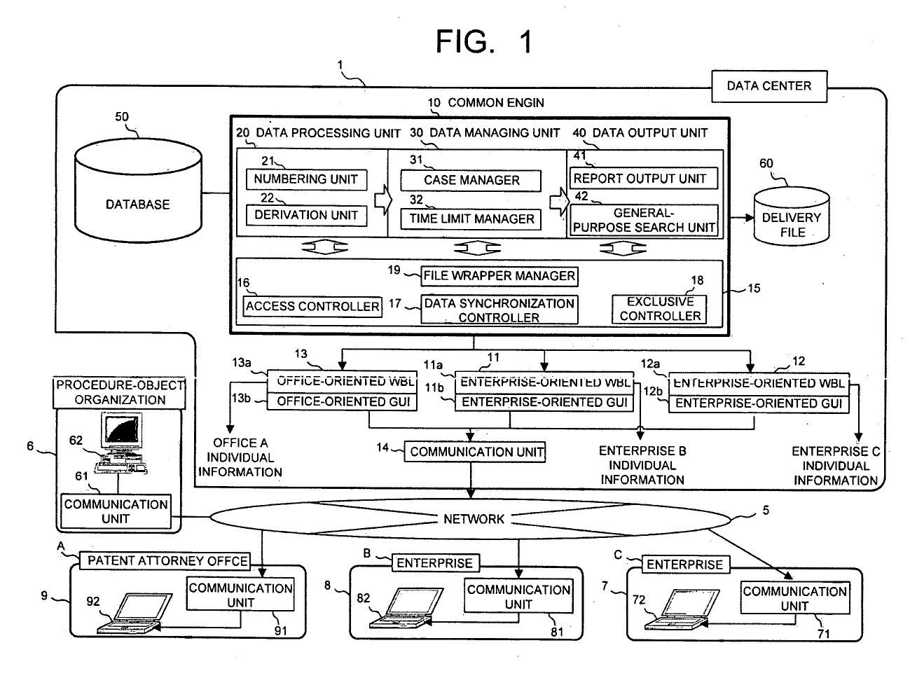

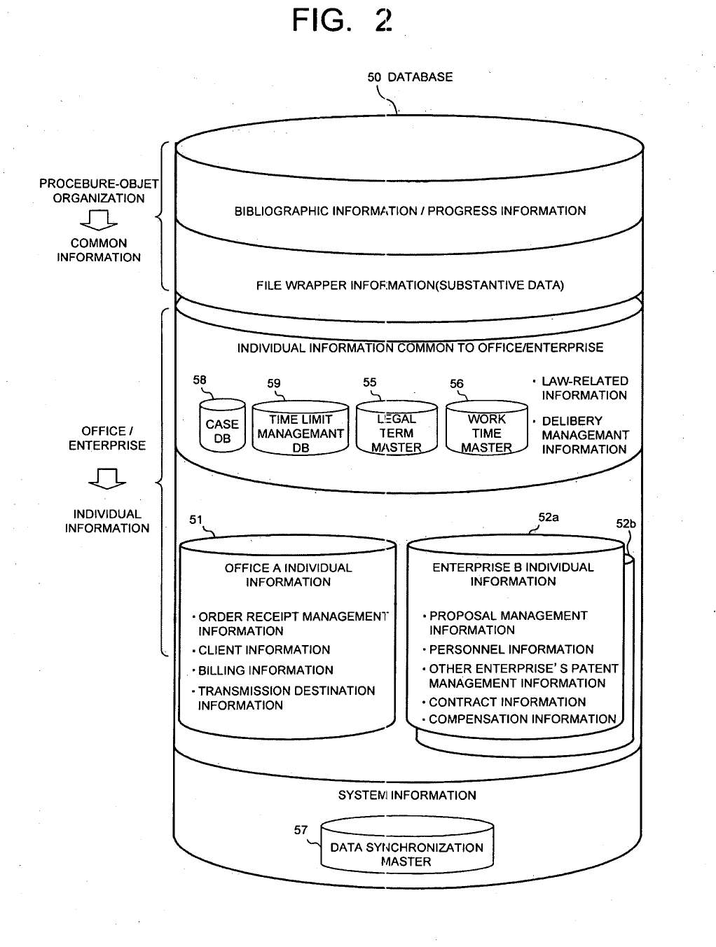

FIG. 1 is a block diagram showing the configuration of an intellectual property managing system according to an embodiment of the present invention and FIG. 2 is a view showing the structure of a database of a common engine of the intellectual property managing system in FIG. 1.

As shown in FIG. 1, this intellectual property managing system includes a server computer 1 installed in a data center of an application service provider (hereinafter abbreviated to ASP), client computer systems 7, 8 installed in enterprises B, C which are patent applicants or those doing the procedure for intermediate processing, a client computer system 9 installed in an office A such as a patent attorney office which offers its service as an agent of the enterprises, a client computer system 6 installed in a procedure-object organization (Patent Office or the like in Japan), and so on, all of which are connected via a network 5.

The client computer system 9 of the office A has a client computer 92 and a communication unit 91.

The communication unit 91 is an apparatus such as a LAN, a hub, or a router connecting the client computer 92 to the server computer 1 via the network 5.

The client computer system 7 of the enterprise C has a client computer 72 and a communication unit 71.

The communication unit 71 is a communication apparatus such as a router connecting the client computer 72 to the server computer 1 via the network 5.

The client computer system 8 of the enterprise B has a client computer 82 and a communication unit 81.

The communication unit 81 is a communication apparatus such as a router connecting the client computer 82 to the server computer 1 via the network 5.

The server computer 1 and the client computers 72, 82, 92 each include: a controller such as a CPU (Central Processing Unit) executing programs; a main storage such as a RAM (Random Access Memory) which is a main memory storing currently executed programs, data, and soon and also serving as a work area in data processing; a database (hereinafter referred to as DB) as a storage unit; an auxiliary storage such as a hard disk drive storing programs and data; input devices such as a keyboard and a mouse; a display device; and so on.

In the hard disk drives of the client computers 72, 82, 92, general-purpose web-browsing softwares such as web browsers are installed. A user accesses the server computer 1 from the web browser to log in.

The server computer 1 may be a stand-alone computer or may be a network system or the like in which a plurality of computers having different functions are connected via a network.

An example of the network 5 is a network for realizing the Internet environment.

A physical communication cable is realized by, for example, a telephone line such as a metal line, an ISDN line, an optic line, a local area network cable (hereinafter referred to as a LAN cable) such as 10/100BASE-T, and a communication unit (optic modem, terminal adapter) connecting these cables to the Internet, and so on.

In the hard disk drive of the server computer 1, a processing module group called a common engine 10 or the like, application softwares 11, 12 designed individually for the enterprises B, C, and an application software 13 designed for the office A are installed.

That is, in the hard disk drive of the server computer 1, job applications are stored so as to be executable.

The application softwares 11, 12, 13 each are called a job processing demanding unit.

It is assumed here that the relation of the enterprise B and the enterprise C is such that, for example, the enterprise B is an applicant of a certain patent application case, and the enterprise C is a co-applicant of the case.

The application software 11 for the enterprise B has a workflow business logic 11a for enterprise (hereinafter referred to as an “enterprise-oriented WBL 11a”) and a graphic user interface 11b for enterprise (hereinafter referred to as an “enterprise-oriented GUI 11b”).

The application software 12 for the enterprise C has a workflow business logic 12a for enterprise (hereinafter referred to as an “enterprise-oriented WBL 12a”) and a graphic user interface 12b for enterprise (hereinafter referred to as an “enterprise-oriented GUI 12b”).

The application software 13 for the office A has a workflow business logic 13a for office (hereinafter referred to as an “office-oriented WBL 13a”) and a graphic user interface 13b for office (hereinafter referred to as an “office-oriented GUI 13b”).

The enterprise-oriented GUIs 11a, 12a and the office-oriented GUI 13b are user interface units provided for the office A, the enterprises B, C, and the procedure-object organization respectively.

The enterprise-oriented WBLs 11a, 12a and the office-oriented WBL 13a are business logic units provided for the office A, the enterprises B, C, and the procedure-object organization respectively.

The enterprise-oriented WBLs 11a, 12a and the office-oriented WBL 13a issue a processing demand to the common engine 10 in response to an instruction from a user.

Concretely, the enterprise-oriented WBLs 11a, 12a and the office-oriented WBL 13a issue a job execution demand to the common engine 10 according to the instruction input from the enterprise-oriented GUIs 11a, 12a and the office-oriented GUI 13b.

At the same time, the enterprise-oriented WBLs 11a, 12a and the office-oriented WBL 13a output, to the enterprise-oriented GUIs 11a, 12a and the office-oriented GUI 13b which are the demanders, results obtained when the common engine 10 executes job processing in response to the job execution demand.

The enterprise-oriented WBLs 11a, 12a and the office-oriented WBL 13a each has an application appropriate for the office or the enterprises, among an application group specialized for jobs such as order receipt management, billing management, invention proposal, filing, intermediate processing, counter measure against invalidation trial, examination status investigation, contract management, invention reporting, request for examination, registration, annual fee payment, compensation management, and budget/actual expense management.

The budget/actual expense management means to manage a budget and an actual expense in a corresponding manner.

The enterprise-oriented GUIs 11a, 12a and the office-oriented GUI 13b each function as an accepting unit accepting operator's browsing of data in the server 1, an operator's input of a job processing instruction, and an operator's instruction for printing the processing result and function as a data display unit.

The communication unit 14 gives, to the enterprise-oriented WBLS 11a, 12a and the office-oriented WBL 13a, job execution instructions which are received from the client computer systems 6, 7, 8, 9 via the network 5.

The communication unit 14 further sends back, to the client computer systems 6, 7, 8, 9, notices of the processing results given from the enterprise-oriented WBLs 11a, 12a and the office-oriented WBL 13a.

The common engine 10 has a data processing unit 20, a data managing unit 30, a data output unit 40, and a data control unit 15.

The common engine 10 functions as a job processing executing unit. The common engine 10 reads relevant information from a database 50 to execute relevant processing in response to demands issued from the enterprise-oriented WBLs 11a, 12a and the office-oriented WBL 13a.

The common engine 10 notifies the processing result to the demander while reflecting information changed as a result of the execution of the processing, in the common information and the individual information in the database 50 according to item correspondence information in a data synchronization master 57.

The data processing unit 20 has a numbering unit 21 and a derivation unit 22. When a new procedure and a new case occur, the numbering unit 21 assigns the reference number to this case according to a pre-set numbering rule.

Since the ASP service is accessed by a large number of clients (the office A, the enterprises B, C, and so on), it is necessary to assign a unique reference number that does not overlap with others.

That is, triggered by the input of the case number (case No.) assigned by the enterprise B or C or the office A, the numbering unit 21 assigns the reference number which can uniquely specify the case in the system, according to the predetermined numbering rule.

The reference number is the number which is different from the case No. assigned by an individual enterprise and is used for identifying the case in the system.

This system has a unique sub-reference number as a system, even if the same reference number is assigned by the procedure-object organization of a plurality of patent attorney offices or the like under contract through the ASP service or the like.

Therefore, in the numbering function of this system, apparent double numbering is allowable, and even when the reference number of one case is changed at each stage involved in the procedure such as reasons for rejection and others, the changed reference numbers can be linked as the numbers for “one case”.

The derivation unit 22 has a derivation control function, a time limit derivation function, a work process derivation function, a fee derivation function, a notice derivation function, and so on. The time limit derivation function is a function of calculating a time limit from case information registered in a case DB 58 (see FIG. 2) in the database 50, in response to an instruction from a case manager 31.

The work process derivation function is a function of deriving a work process for processing the case, from the time limit calculated by the time limit derivation function. The derivation control function is a function of controlling the time limit derivation function and the work process derivation function to generate the schedule of a series or processes of the case.

The fee derivation function is a function of automatically calculating a procedure expense by referring to the contents of data on the result of the procedure and a fee table.

The notice derivation function is a function of notifying a notification timing to the application of a relevant WBL or the like when some action occurs, according to a rule set in advance for each action and defining what kind of notice should be given.

When the case is, for example, a newly filed patent case, the derivation unit 22 having these functions reads data on the filing date of the case from the case DB 58 and by referring to a legal term master 55, determines that the legal term of request for examination of the case differs depending on the filing date (within 3 years or within 7 years).

After the determination, the derivation unit 22 calculates the time limit (date, month, year) of request for examination in the legal term to register the calculated date in the case DB 58, taking out-of-service days (holidays) into consideration.

In calculating the time limit, if the time limit calculated by using a calendar master (not shown) of the database 50 falls on a holiday of the procedure-object organization, the derivation unit 22 performs processing for shifting the time limit to a working day before the holiday or after the holiday (schedule move-up or postpone function).

The data managing unit 30 has the case manager 31, a time limit manager 32, and so on.

The case manager 31 has a bibliographic information storing/managing function, an update history managing unit, a primary information downloading function, a submission document creating function, an electronic filing terminal linking function, and so on.

The bibliographic information storing/managing function enables an access with an appropriate right to bibliographic information managed by the system.

The update history managing function is a function of storing and searching an update history of the bibliographic information. The submission document creating function is a function of downloading various kinds of submission documents from the case DB 58 according to the definition of a submission document master (not shown).

The electronic filing terminal linking function is a function of linking to electronic filing terminals of the office, the enterprises, and the like.

The electronic filing terminal linking function operates in linkage with the primary information downloading function and the submission document creating function.

The electronic filing terminal refers to not only a conventional terminal apparatus dedicated to the electronic filing but also a computer or the like in which personal computer electronic filing software or Internet filing software is installed.

The primary information downloading function is a function of downloading, to the DB 50, the common information received from the procedure-object organization. The common information includes not only the bibliographic information, progress information, and file wrapper information in the database 50 in FIG. 2, but also notice information regarding a filing completion notice, a notice of reasons for rejection, a notice of allowance, and the like.

The primary information downloading function of the case manager 31 stores in and reads from the case DB 58 (see FIG. 2) of the database 50, reception information (a filing completion notice, a notice of reasons for rejection, a notice of allowance, and the like) concerning the case issued from the client computer system 6 of the procedure-object organization.

Further, when the case is, for example, a new patent application, the case manager 31 registers the filing data of the patent case to the case DB 58.

The time limit manager 32 has a ToDo list managing function of setting the term and contents, a time limit, a completion condition, and an alarm date for each case and for each job, and managing them as a ToDo list.

The time limit manager 32 causes the derivation unit 22 to calculate the time limit appropriate for an event when the event occurs in a certain case in the case DB 58.

The time limit manager 32 registers the time limit calculated by the derivation unit 22 to a field (record) of the case in a time limit management DB.

The event refers to, for example, the registration of a new case, the addition of information on a notice received from the procedure-object organization regarding an existing case, the occurrence of a change in the information registered in the case DB 58, and the like.

When a completion event occurs in an individual work process that the derivation unit 22 generates regarding the processing of a case, the time limit manager 32 puts up a completion status to a record, in the case DB, concerning the work process of the case, thereby managing a work status.

In addition to the aforesaid case manager 31 and time limit manager 32, the data managing unit 30 has a work manager, a law manager, a cost manager, and so on, for instance.

The work manager has a transmission/reception managing function, an inquiry managing function, an order managing function, and a stage managing function.

The transmission/reception managing function is a function of managing a process from the start to completion of a work as a series of transactions.

The inquiry managing function is a function of inquiring the decision on whether the request for examination has been submitted or not and whether or not right maintenance is necessary.

The order managing function is a function which, when an order for a case is placed from the enterprise to the office, accepts the order of the case on the office side.

The stage managing function manages stages from order receipt to filing, intermediate processing, registration, right maintenance, and abandonment of the case.

The law manager has a law master and a law logic and is a legal system managing function in which the law logic refers to the law master to perform information control based on the legal system.

The cost manager performs billing management, assets and debts management, actual expense management, budget and actual expense management.

The data output unit 40 has a report output unit 41 and a general-purpose search unit 42.

The general-purpose search unit 42 reads, from the database 50, data (case information regarding an ordered case or the like) designated from the GUI or the like to give it to the report output unit 41, and the report output unit 41 processes the given data into an output form suitable for each delivery destination to output the processed data.

The report output unit 41 outputs the bibliographic information in, for example, a CSV format when a desired data item is designated via the GUI or the like for a case extracted from the database 50 by the general-purpose search unit 42.

The report output unit 41 processes the data managed in the common engine 10 into a delivery format designated by a delivery destination to output it.

For example, the report output unit 41 outputs, as one delivery file 60, a report such as a notice of reasons for rejection, other message files, bill data, and so on, which are stored as the common information in the database 50 and whose delivery is instructed by a file wrapper manager 19.

The delivery file 60 contains not only the case data received from the procedure-object organization (notice of reasons for rejection and the like) but also, for example, data on items reported from the patent attorney office to the enterprise or from the enterprise to the patent attorney office (report of the reasons for rejection and the like), bill data, and the like.

When the case data received from the procedure-object organization is, for example, a notice of reasons for rejection, a section code is insertable in the data on the report items.

The section code is selected in a pull-down menu to be input. A method of inputting the section code may be a key input from a text entry field, checking of a radio button, or the like, instead of the pull-down menu in this example.

According to a predetermined trigger condition, an output item of a report, or the like, the report output unit 41 automatically outputs a report, triggered by, for example, a trigger condition when the trigger condition occurs, or outputs a report at an arbitrary timing when a demand from any of the client computer systems 6 to 9 is given by a user's operation.

The data control unit 15 has an access controller 16, a data synchronization controller 17, an exclusive controller 18, the file wrapper manager 19, and so on.

The data control unit 15 controls a user's access to the common engine 10 and performs exclusive control of data. That is, the data control unit 15 performs filtering control to the common engine 10 from an external part.

When a user gives a log-in demand to the server computer 1 from any of the client computer systems 6 to 9, the access controller 16 uses, as a key, a user ID included in log-in information notified from the relevant one of the client computer systems 6 to 9 to permit the user to access the data in the masters and the DBs of the database 50 according to an access right of each user ID stored in an ID master (not shown) of the database 50.

When a plurality of users try to access some data stored in the database 50 and one of the users has first accessed (referred to or edited) the data, the exclusive controller 18 thereafter does not permit the access by a user who tries to access the data.

That is, when a user has accessed the data in the database 50, the exclusive controller 18 functions as an access control unit restricting the access to the data from other users.

The file wrapper manager 19 manages electronic filewrappers of cases and attached files in linkage with the bibliographic information.

In response to a demand for delivering the case processing result to a delivery destination from a delivery origin, the file wrapper manager 19 selects the delivery destination, reads the case information for delivery from the case DB 58, and instructs the data synchronization controller 17 to deliver a delivery file to the DB (the office A individual information, the enterprise B individual information, the enterprise C individual information, or the like) of the delivery destination.

The data synchronization controller 17 synchronizes the data in the delivery file whose delivery is instructed by the file wrapper manager 19, with corresponding items and data in the DB of the delivery destination, that is, the DB in which the individual information of the office or the enterprise is stored.

That is, the data synchronization controller 17 data-converts the data in the delivery file into another item of the individual information according to an item correspondence table to update the DB.

In the item correspondence table, information indicating a correspondence relation between items of the individual information of the office and items of the individual information of each enterprise is stored.

In response to the demand for delivering the case processing result (delivery file) to the delivery destination from the delivery origin, the file wrapper manager 19 extracts the delivery destination from the case DB to store the information on the case processing result (delivery file) in the DB (the office A individual information, the enterprise B individual information, the enterprise C individual information or the like) of the delivery destination.

The data control unit 15 has a group managing unit, an access log unit, an authenticating unit, and so on in addition to the aforesaid functions.

The group managing unit shares cases in which an enterprise group is involved. The access log unit stores and reads not only the update history but also access logs of calls of a search function and calls of other various functions.

The authenticating unit performs user authentication by comparing input log-in information and authentication information registered in the database 50. Concretely, the authenticating unit uses, as a keyword, the log-in information (user ID and password) included in a log-in demand received through the network 5 to search for authentication registration data (user ID and password) registered in the ID master (not shown) of the database 50 in advance, and determines whether to permit the log-in of the log-in demand, based on whether or not the log-in information matches the registration data.

In the server computer 1, the database 50 is provided as shown in FIG. 2. In the database 50, stored are the common information obtained from the procedure-object organization, the individual information common to the office and the enterprises, the individual information of each of the office, the enterprises, and the like, and system information.

Examples of the common information obtained from the procedure-object organization are bibliographic information, progress information, file wrapper information (substantive data), and so on.

In the database 50, individual DBs such as an office A individual information DB 51, an enterprise B individual information DB 52a, and an enterprise C individual information DB 52b are provided, and the individual information of the office A and the individual information of the enterprises B, C are stored in the respective DBs.

That is, in the database 50, stored are: the common information on intellectual properties exchanged among the procedure-object organization, the enterprises B, C, and the office A; and the individual information individually managed by the procedure-object organization, the enterprises B, C, and the office A.

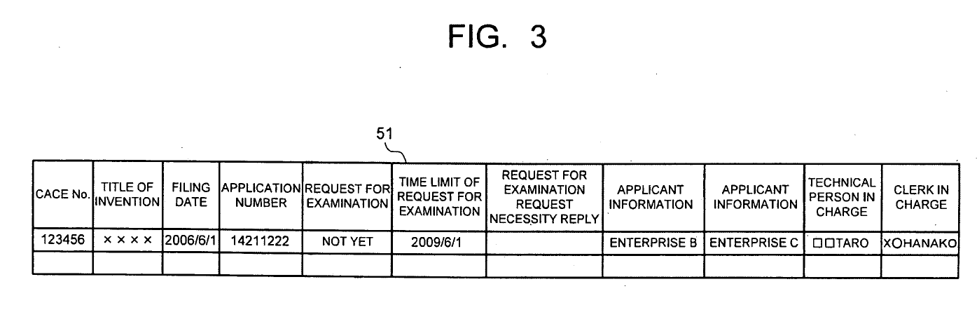

As shown in FIG. 3, in the office A individual information DB 51, title of invention, filing date, application number, whether the request for examination has been submitted (“submitted” or “not yet”), time limit of request for examination, request for examination request necessity reply, applicant information, applicant information, technical person in charge, clerk in charge, and so on are stored as one record in correspondence to the case number (case No.).

This DB is an example where a case (case number “123456”) is patent application and the enterprise B and the enterprise C are co-applicants, and as one of two pieces of the applicant information, “enterprise B” is registered, and as the other applicant information, “enterprise C” is registered.

That is, in the office A individual information DB 51, information on all the cases of intellectual properties filed by the patent attorney office employing this system is stored.

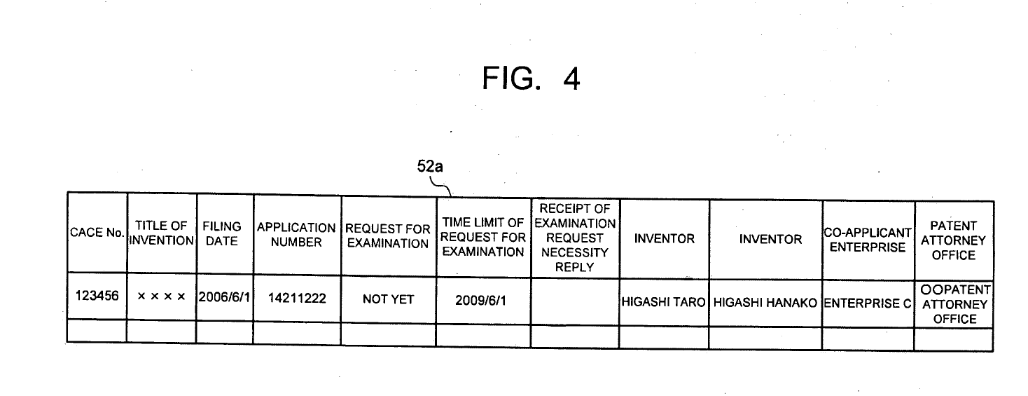

As shown in FIG. 4, in the enterprise B individual information DB 52a, title of invention, filing date, application number, whether request for examination has been submitted (“submitted” or “not yet”), time limit of request for examination, receipt of examination request reply, inventor, inventor, co-applicant enterprise, patent attorney office, and so on are stored as one record in correspondence to the case number (case No.).

Since this DB is a DB of the enterprise B, “Higashi Taro”, “Higashi Hanako”, or the like are registered as inventors of the own enterprise, and “enterprise C” is registered as a co-applicant enterprise.

That is, in the enterprise B individual information DB 52a, information on all the cases of intellectual properties filed by the enterprise B employing this system is stored.

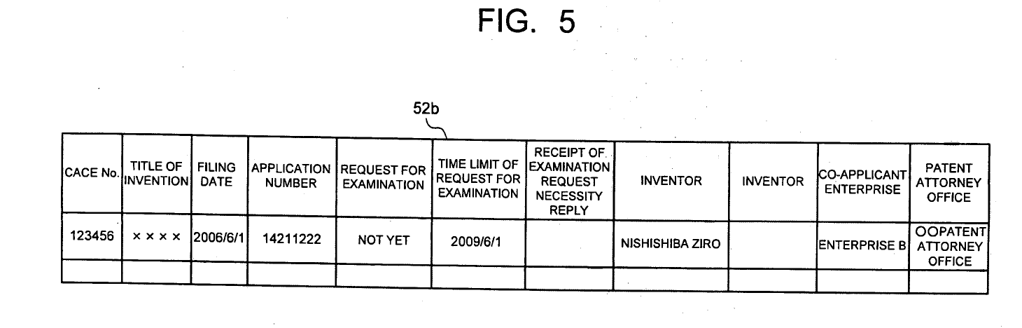

As shown in FIG. 5, in the enterprise C individual information DB 52b, title of invention, filing date, application number, whether request for examination has been submitted (“submitted” or “not yet”), time limit of request for examination, receipt of examination request reply, inventor, inventor, co-applicant enterprise, patent attorney office, and soon are stored as one record in correspondence to the case number (case No.).

Since this DB is a DB of the enterprise C, “Nishishiba Jiro” is registered as an inventor of the own enterprise, and “enterprise B” is registered as a co-applicant enterprise. The other items are the same as those of the DB of the enterprise B.

That is, in the enterprise C individual information DB 52b, information on all the cases of intellectual properties filed by the enterprise C employing this system is stored.

In the database 50, the legal term master 55, a work time limit master 56, the data synchronization master 57, the case DB 58, a time limit management DB 59, and so on are provided.

In each of the DBs, the individual information input by each of the office and the enterprises is stored. In each of the masters, the common information commonly used by the office and the enterprises is stored.

The data synchronization master 57 is stored as system information in the database 50.

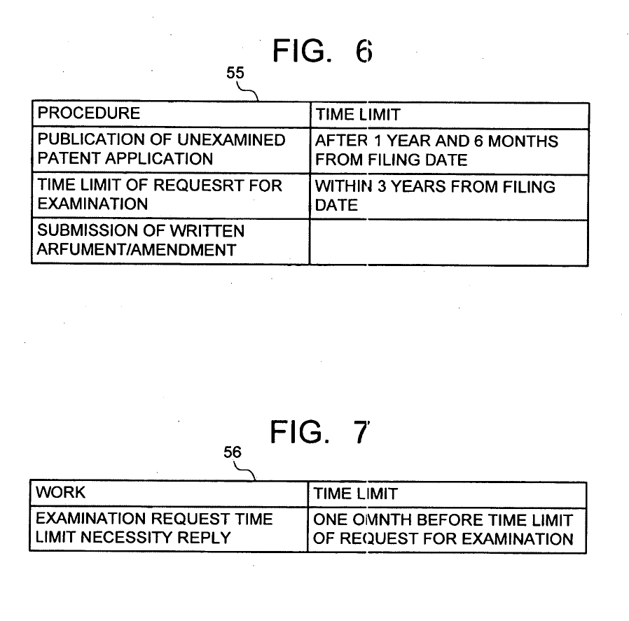

As shown in FIG. 6, in the legal term master 55, the legal term is stored for each procedure. The legal term includes the following information. For example, publication of unexamined patent application takes place after one year and six months has passed from the filing date.

The time limit of request for examination of a patent filed on or before Sep. 30, 2001 is within 7 years from the filing date. The time limit of request for examination of a patent filed on or after Oct. 1, 2001 is within 3 years from the filing date. “Submission of written argument/amendment” in response to, for example, a notice of reasons for rejection should be made within 2 months from the date of notice from the procedure-object organization.

As shown in FIG. 7, in the work time limit master 56, a time limit is stored for each work. For example, the time limit of the examination request necessity reply is one month before the time limit of request for examination. This time limit can be arbitrarily set since it is not a legal term.

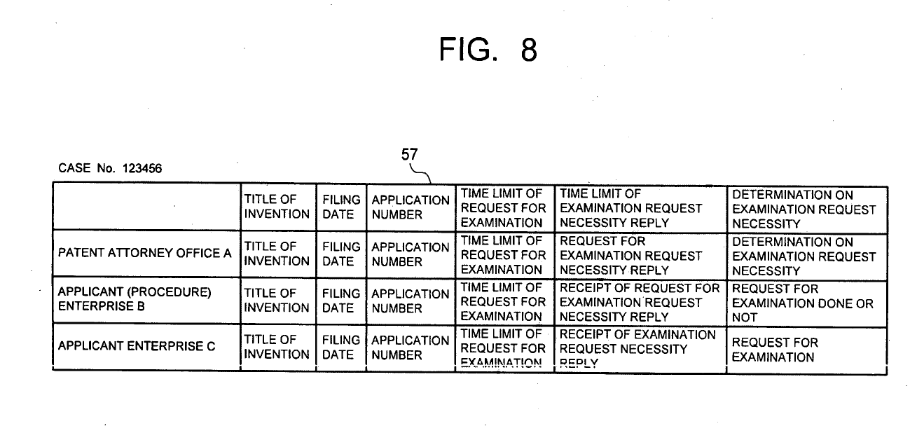

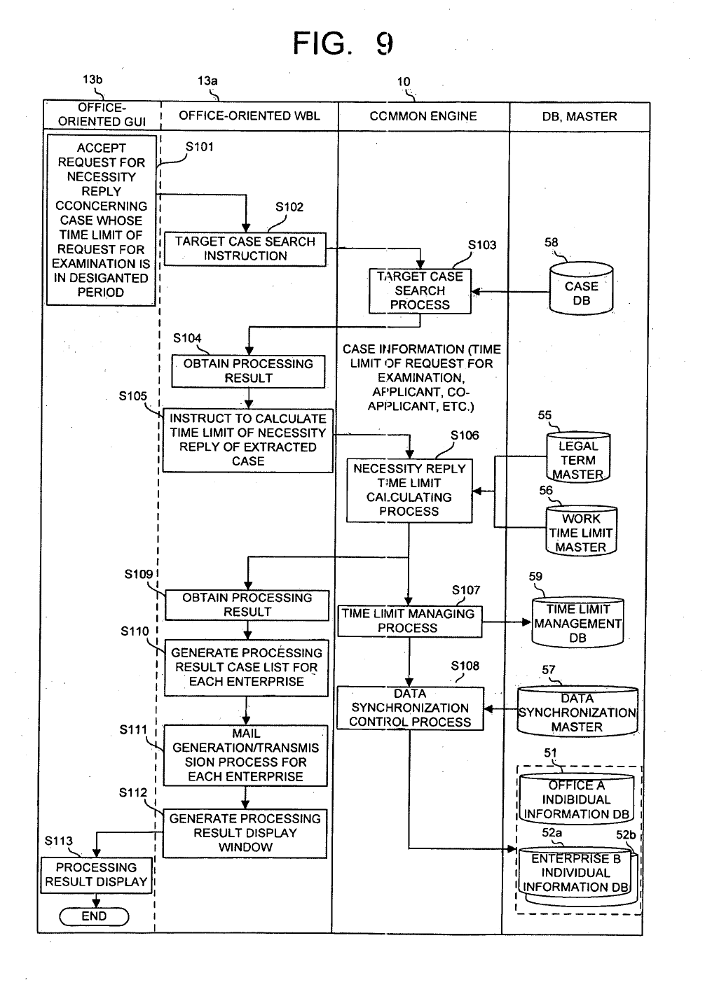

As shown in FIG. 8, in the data synchronization master 57, item-correspondence information indicating how items of involved office and enterprises correspond to one another is stored for each case No. The data synchronization master 57 is referred to at the time of the data synchronization by the data synchronization controller 17.

In this example, for example, regarding “time limit of examination request necessity reply,”, an item of the office A is “request for examination request necessity reply”, but an item of the applicant enterprise B is “receipt of request for examination request necessity reply”, and an item of the applicant enterprise C is “receipt of examination request necessity reply”.

Further, regarding “determination on examination request necessity”, an item of the office A is “determination result on examination request necessity”, but an item of the applicant enterprise B is “request for examination done or not” and an item of the applicant enterprise C is “request for examination”.

That is, in this data synchronization master 57, there is stored correspondence information used in converting each item of the individual information, which is individually managed in the database 50 on per enterprise basis and on per office basis, into another.

In the case DB 58, various kinds of appendant information based on which the case is to be processed or was processed are registered in correspondence to the reference number (case No.) which is assigned to a case when the case newly occurs.

Concretely, in the case DB 58, the case information is stored such as, for example, a category of the intellectual property (one of patent, utility model, design, trademark, and the like), filing date, date of request for examination, presence/absence of notice of reasons for rejection, registration date, the number or name of an ordering enterprise, the case number of the ordering enterprise, technical person in charge of the enterprise, the number of an order-receiving office, the name of the order-receiving office, and a technical person in charge of the office.

Hereinafter, the operation of the intellectual property managing system will be described with reference to FIG. 9 to FIG. 14.

A description will be given of two operation examples where the common engine 10 of the server computer 1 operates in different manners in response to a demand from a business logic (the office-oriented WBL 13a, the enterprise-oriented WBL 11a, 12a, or the like).

For example, a description will be given of the operation when the office A gives a request to the enterprise B in order to confirm the necessity or not of request for examination concerning a case whose time limit of request for examination is in a designated period.

In this case, when a predetermined URL is entered into a window of the web browsing software such as the web browser which is activated in the client computer 92 of the client computer system 9 of the office A, an access demand is sent from the client computer 92 to the server computer 1 of the data center.

In the server computer 1, the office-oriented WBL 13 gives the common engine 10 the access demand received via the communication unit 14.

In the common engine 10, the access controller 16 of the data control unit 15 sends back a log-in window in response to the access demand, and performs a user authentication process by using, as a keyword, the log-in information (user ID and password) input from the log-in window.

In the user authentication process, the registration data (user ID, password, right) which is the authentication information registered in the ID master of the database 50 in advance is searched for, and it is determined whether to permit the log-in of the log-in demand or not, based on whether or not the log-in information matches the user ID and the password in the registration data.

When the user authentication process finds that the log-in information matches the registration data, the access controller 16 permits the log-in to the server computer 1 under the right registered in the ID master. Consequently, a menu window (not shown) is displayed on the client computer 92.

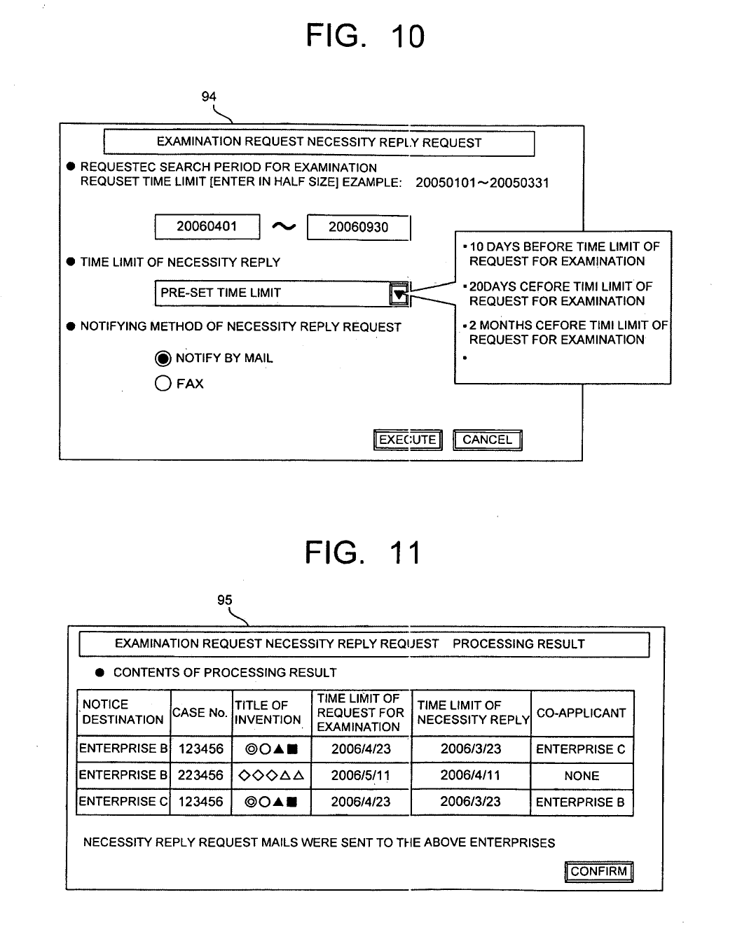

Here, when a user (operator) operates a button of examination request necessity reply request on the menu window, an examination request necessity reply request window 94 is displayed on the client computer 92 as shown in FIG. 10, and accordingly, in order for the office A to request the enterprise B for the necessity reply regarding a case whose time limit of request for examination is in a certain period, the user inputs values to or operates fields of “requested search period for examination request time limit”, “time limit of necessity reply”, “notifying method of necessity reply request”, and so on and then operates an execute button.

Then, the office-oriented GUI 13a accepts the input and operation (S101) and sends, to the office-oriented WBL 13a, a demand for outputting the request for necessity reply concerning a case whose time limit of request for examination is in the input period (S102).

Incidentally, “time limit of necessity reply” is shown as a pull-down menu. In the pull-down menu, for example, “pre-set time limit”, “10 days before time limit of request for examination”, “20 days before time limit of request for examination”, “2 months before time limit of request for examination”, and the like are set, and by selecting one of the time limits, it is possible to transmit the request for necessity reply at a timing appropriate for the selected menu.

A means used for the designation of “time limit of necessity reply” may be not only the pull-down menu in this example but also a key input from a text entry field, checking of a radio button, or the like.

In this example, as “requested search period for examination request time limit”, it is assumed that, for example, “20060401” is input as the starting date and “20060930”is input as the final date so that a certain period is designated.

Upon receipt of the demand for sending the request for examination request necessity reply, the office-oriented WBL 13a sends a target case search instruction to the common engine 10.

Upon receipt of the target case search instruction, the common engine 10 executes a target case search process in the case DB 58 by using the designated period as a keyword (S103) and sends back information on the hit cases to the office-oriented WBL 13a. The case information obtained as a result of the search process includes the time limit of request for examination, applicant, co-applicant, and the like. Incidentally, not only the term but also the designation of a range of the case No. may be used together.

When obtaining the processing result from the common engine 10, the office-oriented WBL 13a sends, to the common engine 10, an instruction for calculating the time limits of necessity reply of the extracted cases (S105).

Upon receipt of the instruction for calculating the time limits of the necessity reply, the common engine 10 executes a necessity reply time limit calculating process (S106).

In this case, the common engine 10 finds a legal time limit of request for examination by adding a legal term of request for examination (in a case of patent, 3 years: 365 days×3=1095 days) read from the legal term master 55 to the filing date of the case (date xx, month xx, year xxxx).

The common engine 10 subtracts an interval period (20 days if the time limit is 20 days before) read from the work time limit master 56 from the legal time limit of request for examination to calculate the time limit of the necessity reply of the case and sends back the processing result to the office-oriented WBL 13a which is a demander.

The common engine 10 executes a time limit managing process by registering the calculated time limit of the necessity reply of the case in the time limit management DB 59 (S107).

Concretely, the common engine 10 registers a ToDo item concerning the case in the time limit management DB 59 based on newly generated or updated data.

Next, the common engine 10 executes a data synchronization control process according to the correspondence information in the data synchronization master 57 by referring to the data synchronization master 57 (S108), thereby reflecting the contents of the updated data of this case in the individual information DBs of the office A and the involved enterprises B, C.

That is, the common engine 10 extracts data which are to be synchronized and updates data of corresponding items in the office A individual information DB 51, the enterprise B individual information DB 52a, and the enterprise C individual information DB 52b.

Upon obtaining the processing result (S109), the office-oriented WBL 13a generates a processing result case list for each relevant enterprise (S110) to generate a mail addressed to each enterprise, and performs a transmission process of the mail (S111).

Further, the office-oriented WBL 13a generates a processing result display window displaying the processing result (S112) to give it to the office-oriented GUI 13b.

The office-oriented GUI 13b displays, on the client computer 92, a processing result display window 95, shown in FIG. 11, received from the office-oriented WBL 13a (S113).

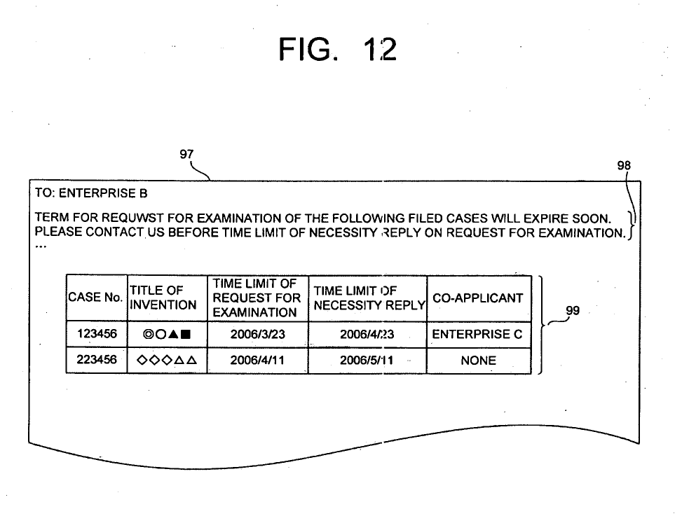

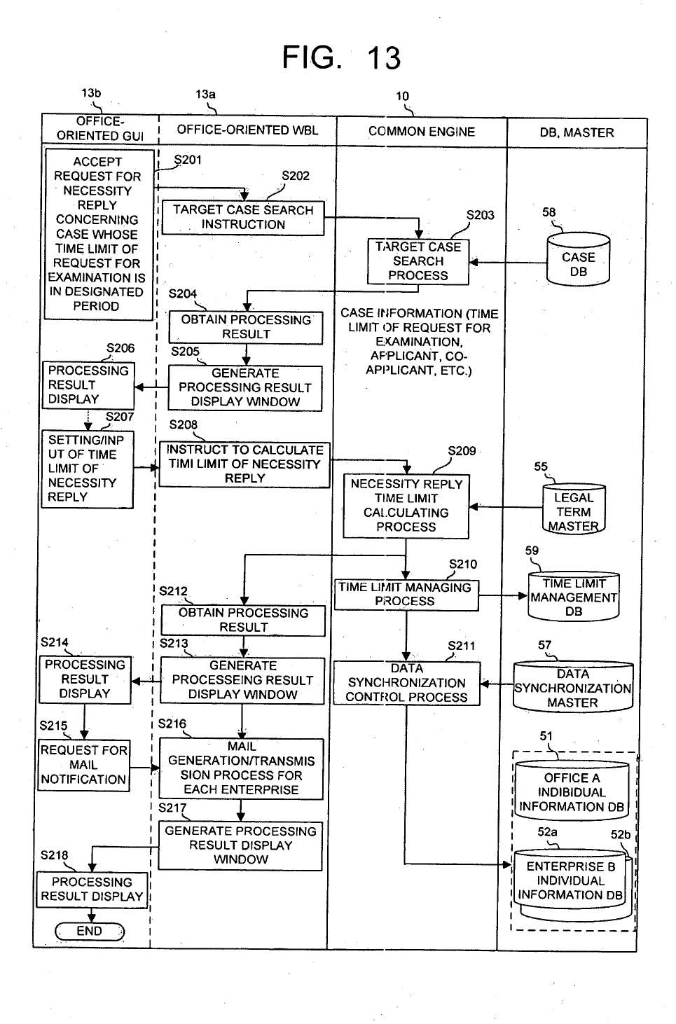

This enables an operator of the office A to confirm, as the processing result, the contents of the request mails for examination request necessity reply transmitted to the enterprises B, C, that is, the contents of mails asking them to reply (see FIG. 12).

As shown in FIG. 12, on a mail window 97, the name of the addressee enterprise, pre-set header information 98, information 99 on cases whose time limits of request for examination are in “20060401” to “20060930” (“case No.”, “title of invention”, “time limit of request for examination”, “time limit of necessity reply”, “co-applicant”) are inserted.

In this example, two cases of the enterprise B match the condition and the reply request mail is addressed to the enterprise B. The header information 98 part is a fixed phrase.

Next, the operation of the common engine 10 when the office-oriented WBL 13a is modified clue to a specification change or the like will be described.

In the above operation example, the logic is configured so that the reply request mail is automatically transmitted on the pre-set time limit, but this logic is modified so that, for example, the request for necessity reply for each case whose time limit of request for examination is in a designated period is sent each time to the relevant enterprise.

In this case, similarly to the above, a user accesses the server computer 1 from the client computer 92 and logs in after the user authentication.

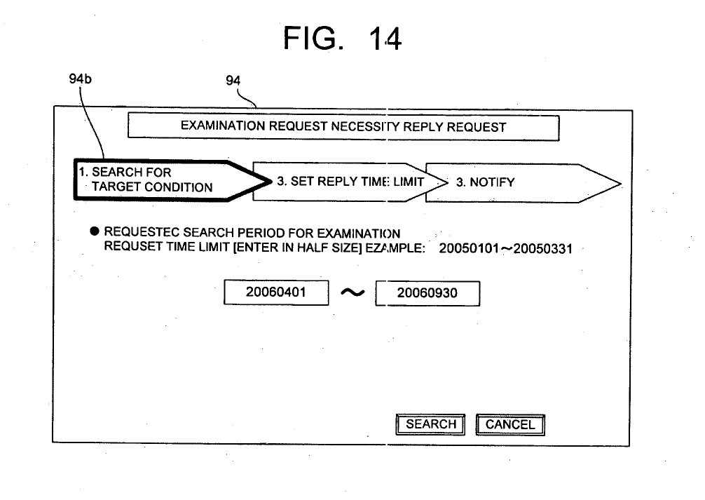

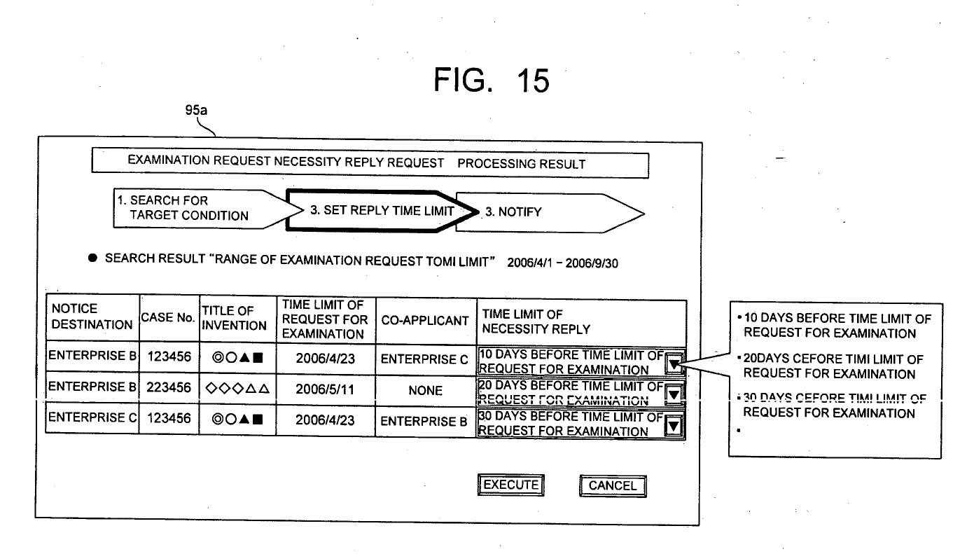

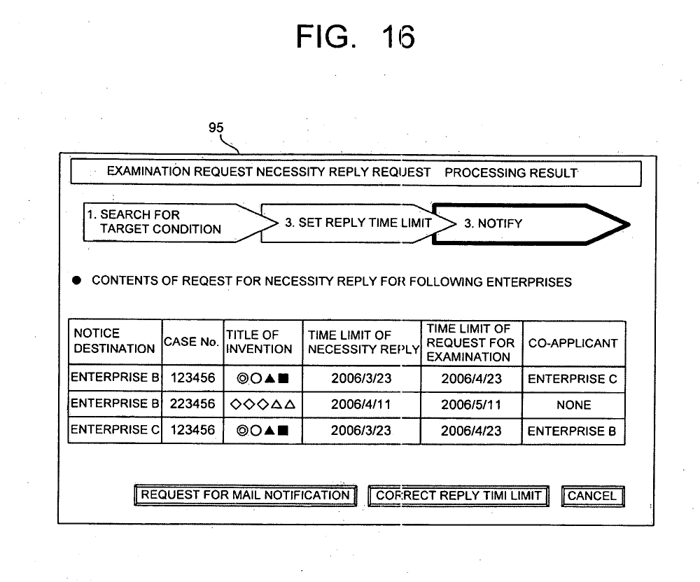

Then, in order to search for a case whose time limit of request for examination is in the designated period, the operator operates the button of examination request necessity reply request on the menu window (not shown), and accordingly, an examination request necessity reply request window 94a is displayed on the client computer 92 as shown in FIG. 14.

On the examination request necessity reply request window 94a, a progress state display part 94b showing a progress state of the processing and an entry field of “requested search period for examination request time limit” are displayed. The progress state display part 94b shows three steps such as “1.target condition case”, “2. set reply time limit”, “3. notify” are shown by arrows.

In the progress state display part 94b, a highlighted step (arrow portion) changes depending on the progress state of the processing, and therefore, according to the display position in the progress state display part 94b, the user can determine at which step the processing currently is.

When the operator inputs the start date and the final date into the entry field and operates a search button, the office-oriented GUI 13a accepts the input and the operation (S201) and sends, to the office-oriented WBL 13a, a demand for sending the necessity reply request concerning a case whose time limit of request for examination is in the input period (S202).

In this example, it is assumed that as “requested search period for examination request time limit”, “20060401” is input as the start date and “20060930” is input as the final date, for instance, so that a certain period is designated.

Upon receipt of the demand for sending the request for examination request necessity reply, the office-oriented WBL 13a sends a target case search instruction to the common engine 10.

Upon receipt of the target case search instruction, the common engine 10 executes a target case search process in the case DB 58 by using the period and the case No. as a keyword (S203).

Then, the common engine 10 sends back the case information that is hit as a result of the search process to the office-oriented WBL 13a. The case information obtained as a result of the search process includes the time limit of request for examination, an applicant, a co-applicant, and so on.

Upon obtaining the processing result from the common engine 10 (S204), the office-oriented WBL 13a generates a processing result display window displaying the processing result (S205) to give it to the office-oriented GUI 13b.

The office-oriented GUI 13b displays the processing result display window 95a, shown in FIG. 14, which is received from the office-oriented WBL 13a, on the client computer 92 (S206).

On the processing result display window 95a, there are provided information (“case No.”, “title of invention”, “time limit of request for examination”, “co-applicant”, and “time limit of necessity reply”) on the cases whose time limits of request for examination are in the designated period.

For the “time limit of necessity reply”, a pull-down menu is displayed so that it can be set for each case. In the pull-down menu, for example, “10 days before time limit of request for examination”, “20 days before time limit of request for examination”, “30 days before time limit of request for examination”, and the like are set, and by selecting one of the time limits, it is possible to transmit the request for the necessity reply at a time appropriate for the menu.

A means used for the designation of “time limit of necessity reply” may be not only the pull-down menu in this example but also a key input from a text entry field, checking of a radio button, or the like.

When the operator selects one from the pull-down menu of “time limit of necessity reply” here, the office-oriented GUI 13b accepts the setting and input of the selected time limit (S207) to give it to the office-oriented WBL 13a.

The office-oriented WBL 13a instructs the common engine 10 to calculate the time limits of necessity reply based on the received time limits of necessity reply (S20E).

Upon receipt of the instruction for calculating the time limits of necessity reply, the common engine 10 executes a necessity reply time limit calculating process (S209).

In this case, the common engine 10 adds a legal term of request for examination (three years: 365 days×3=1095 days, if a patent is filed on or after Oct. 1, 2001) read from the legal term master 55 to the filing date of the case, thereby finding a legal time limit of request for examination, and subtracts the set/input date (for example, 20 days if the 20 days before the time limit of request for examination is input) from the legal time limit of request for examination, thereby calculating the time limit of necessity reply.

The common engine 10 further subtracts the interval period read from the work time limit master 56 to calculate the time limit of the necessity reply concerning the case and sends back the processing result to the office-oriented WBL 13a which is a demander.

The common engine 10 executes a time limit managing process by registering the calculated time limit of necessity reply concerning the case in the time limit management DB 59 (S210).

Concretely, the common engine 10 registers a ToDo item concerning the case in the time limit management DB 59 based on newly generated or updated data and receives a completion date input by the operator after the ToDo item is executed, thereby managing how the work proceeds (progress state).

Next, the common engine 10 executes a data synchronization control process according to the correspondence information in the data synchronization master 57 by referring to the data synchronization master 57 (S211), thereby reflecting the contents of the updated data concerning this case in the individual information DBs of the office A and the relevant enterprises B, C.

That is, the common engine 10 extracts data which are to be synchronized and updates data of corresponding items in the office A individual information DB 51, the enterprise B individual information DB 52a, and the enterprise C individual information DB 52b.

When obtaining the processing result of the common engine 10 (S212), the office-oriented WBL 13a generates a processing result display window displaying the processing result (S213) to give it to the office-oriented GUI 13b. The office-oriented GUI 13b displays a processing result display window 97a shown in FIG. 16.

On the processing result display window 97a, the contents of the request for necessity reply for each enterprise, a mail notice request button, a reply time limit correction button, a cancel button, and so on are displayed.

Items displayed as the contents of the request for necessity reply for each enterprise are “notice destination”, “case No.”, “title of invention”, “time limit of necessity reply”, “time limit of request for examination”, and “co-applicant”.

When the mail notice request button is selected and operated here, the office-oriented GUI 13b gives the operation/input to the office-oriented WBL 13a.

Upon receipt of the input of the mail notice request, the office-oriented WBL 13a generates a processing result case list for each enterprise included in the processing result, and creates a mail for each enterprise according to the processing result case list to execute a transmission process (S216).

Further, the office-oriented WBL 13a generates a processing result display window displaying the processing result (S217) to give it to the office-oriented GUI 13b.

The office-oriented GUI 13b displays the processing result display window received from the office-oriented WBL 13a on the client computer 92 (S218).

Consequently, an operator of the office A can confirm, as the processing result, the contents of the request mails for examination request necessity reply transmitted to the relevant enterprises B, C, that is, the contents of the mails asking the enterprises B, C to reply (see FIG. 12).

As described above, according to the intellectual property managing system of this embodiment, in order to make it possible to share patent information of each case by an office and an enterprise or by enterprises which should share the case information, a software component and a database structure (function) that can be made common irrespective of enterprises are prepared as the common engine 10, and the specification of a demand given to the common engine 10 is made open, so that the business logic (WBL) and the interface (GUI) can be individually prepared for use by each of the enterprises and the office, which can reduce the influence of a specification change accompanying law amendment, service change, and so on to a minimum while making best use of the GUI and application function quite unique to each enterprise.

Concretely, upon receipt of a demand for job processing from the business logic (WBL) as the job processing demanding unit, the common engine 10 as the job processing executing unit executes the job processing according to the demand.

Then, when as a result of the job processing, there occurs some data that should be shared with other enterprises, the common engine 10 notifies the processing result to a demander while reflecting the updated data in the individual information of each enterprise according to the correspondence information in the data synchronization master 57.

Further, regarding demands generated from unique business logics of a patent attorney office and an enterprise, the common engine 10 behaves in the same manner to process the demands even when they are from a plurality of different applications, and sends back the processing results to the individual applications of the demanders, which makes it possible to share information on each case by a patent attorney office and an applicant or by different enterprises.

Therefore, it is possible to confirm difference of the time limits and the progress states concerning the respective cases, which ensures that responses to the procedure-object organization such as the Patent Office (receipt of a notice of reasons for rejection and a notice of allowance, and various kinds of procedures for which legal terms are set) are executed.

Further, application software is separated into those for the respective job functions such as the common engine 10 and the business logic, and therefore, it is possible to localize a place for change when, for example, the specification of the system is to be changed according to patent-related law amendment, revision of service, and so on.

In particular, with the recent progress of law amendment and abolish or merge of enterprises such as merging of enterprises, many parts of various systems have to be united in the system maintenance work, and owing to the separated configuration into the common engine 10 and the business logics (the office-oriented WBL 13a and the office-oriented GUI 13b, the enterprise-oriented WBLs 11a, 12a and the enterprise-oriented GUIs 11b, 12b, and the like), the maintenance of the common engine 10 can be left to a company supporting only the common engine 10, and a company in charge of maintenance of a business logic part only has to work on a system change focusing on the individual application part such as GUI and WBL, which realizes improved maintenance efficiency.

It should be noted that the present invention is not limited to the above-described embodiment though one embodiment for realizing the present invention is described above, and various changes can be made therein without departing from the spirit of the present invention.

The above embodiment describes the exchange of data, mainly between the enterprise and the office and between the enterprises, but data may be exchanged among three parties such as among a procedure-object organization, an enterprise, and an office, and among a procedure-object organization, an enterprise, and an enterprise, or may be exchanged between a procedure-object organization and an enterprise or between a procedure-object organization and an office. That is, the intellectual property managing system is applicable to data exchange by at least two of a procedure-object organization, an enterprise, and an office.

The above embodiment describes the example where the system is of an ASP type in which dedicated software other than general-purpose browser software is not installed in the computers 72, 82, 92 of the office and the enterprises, but besides, the system may be configured as an in-house+ASP type or an in-house type.

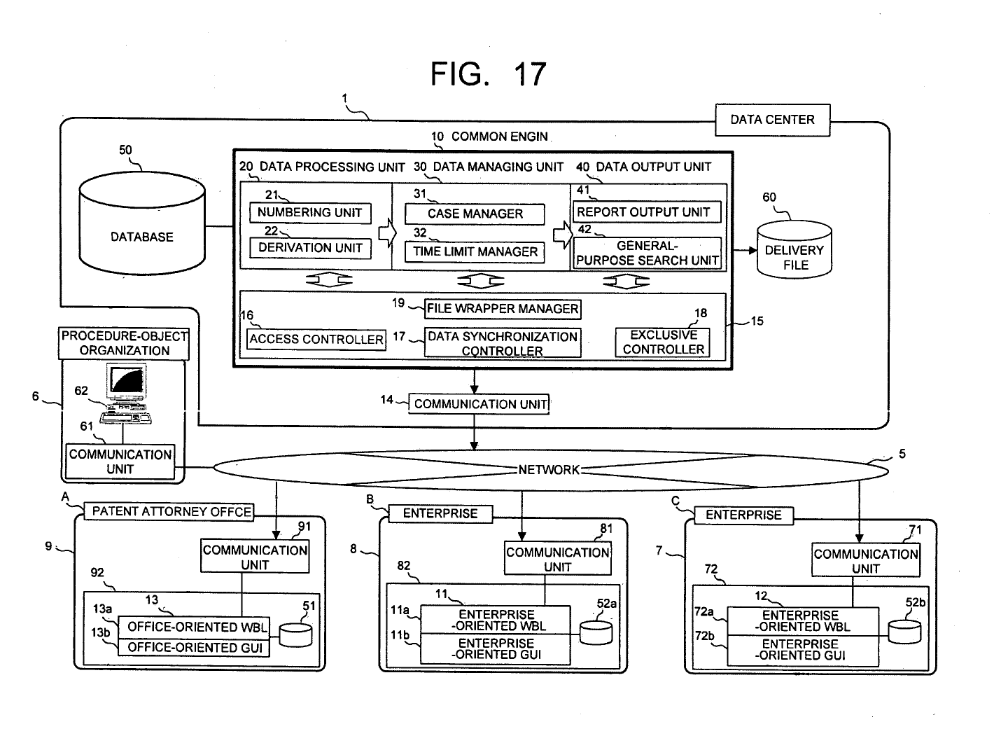

As shown in FIG. 17, for instance, in the in-house+ASP type system, the part corresponding to the common engine 10 is installed in the server computer 1 of the data center.

On the other hand, in the computers 72, 82 of the enterprises, WBLs 11a, 12a and GUIS 11b, 12b are installed as enterprise-oriented patent managing systems.

Further, in the client computer 92 of the office, WBL 13a and GUI 13b are installed as an office-oriented patent managing system.

That is, in the intellectual property managing system of this embodiment, the common engine 10 (job processing executing unit), the database 50, and the data synchronization master in the database 50 are provided in the server computer 1 connected to the network 5, and the job processing demanding units such as the WBLs 11a, 12a, 13a and the GUIs 11b, 12b, 13b are provided in the client computers 72, 82, 92 connected to the network 5.

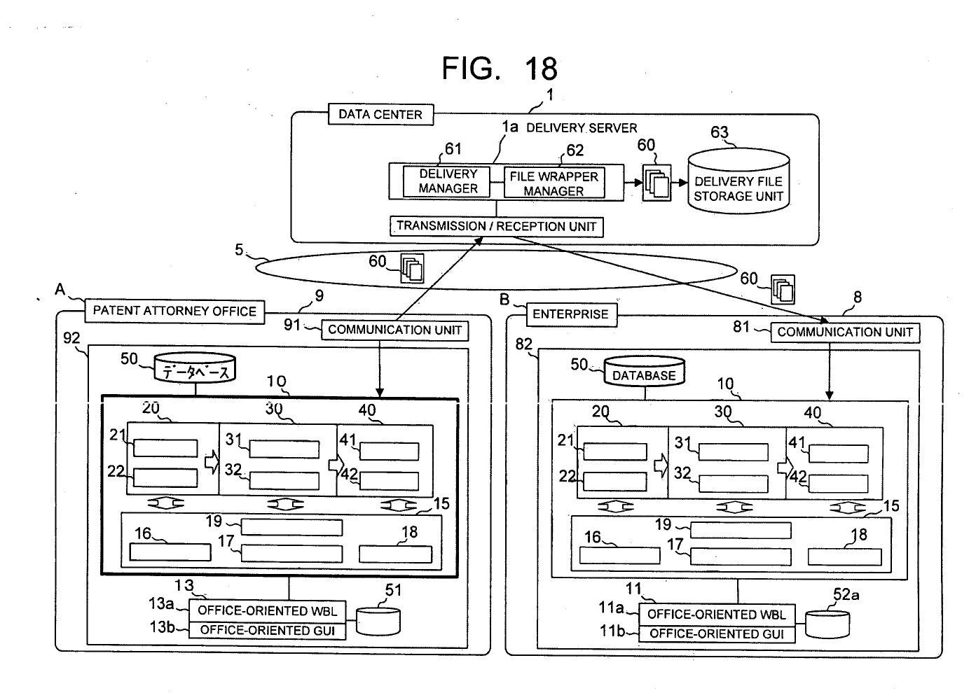

Further, as shown in FIG. 18, in the in-house type system, softwares in each of which the common engine 10, the WBL 11a, 13a, and the GUI 11b, 13b are combined are installed in the computers 82, 92 of the office and the enterprise respectively.

In the server computer 1, a delivery server software 1a (in the drawing, shown as a delivery server 1a) for exchanging the delivery file 60 between the office and the enterprise is installed.

In the in-house type system, data synchronization is taken in data exchange via the server computer 1, that is, in the exchange of the delivery file 60.

In the intellectual property managing system of this embodiment, the client computer 92 of a delivery origin, the client computer 82 of a delivery destination, and the server computer 1 are connected to the network 5, and the delivery file 60 transmitted from the client computer 92 of the delivery origin is transferred and delivered by the server computer 1 to the client computer 82 of the delivery destination.

The delivery server software la includes a delivery manager 61 and a file wrapper manager 62. The file wrapper manager 62 receives the delivery file 60, which is the result of processing the case, addressed to the delivery destination from the delivery origin and stores the delivery file 60 in a delivery file storage unit 63.

The delivery manager 61 reads bibliographic information contained in the delivery file 60 stored in the delivery file storage unit 63 and collates the read information with pre-registered identification information of the delivery destination to check whether or not the identification information of the delivery destination is correct.

When it is found from the check that the identification information of the delivery destination is correct, delivery permission is notified to the delivery manager 61. Upon receipt of the notice of the delivery permission from the file wrapper manager 62, the delivery manager 61 transfers the delivery file 60 stored in the delivery file storage unit 63 to the delivery destination.

Here, since only the bibliographic information in the delivery file 60 is checked, there may be a case where the delivered substantive data itself is not correct.

Therefore, in the route from the delivery origin to the delivery destination, the delivery file 60 is encoded so as to prevent the delivery file 60 from being opened when the delivery file 60 is delivered to an improper delivery destination.

Further, the delivery origin and the delivery destination often do not know the other party's situation. For example, even if the delivery origin sent the delivery file 60, the delivery origin does not know when the delivery file 60 reached the delivery destination.

Further, for reasons of jobs, the delivery destination, though having received the delivery file 60, sometimes leaves the delivery file 60 unopened.

Therefore, in the server computer 1, the delivery manager 61 monitors the opening state of the delivery file 60 after the delivery file 60 is transferred to the client computer 82 of the delivery destination via the network 5.

After the delivery, when finding, during the monitoring of the opening state, that the delivery file 60 is opened in the client computer 82 of the delivery destination within a predetermined period, the delivery manager 61 automatically issues an electronic mail notifying that the delivery file 60 has been opened, to a pre-registered electronic mail address of the client computer 92 of the delivery origin.

On the other hand, after the delivery, when the predetermined period has passed during the monitoring of the opening state, the delivery manager 61 automatically generates a reminding letter with fixed phrase, and automatically issues an electronic mail with the reminding letter attached, to a pre-registered electronic mail address of the client computer 8 of the delivery destination, thereby urging the delivery destination to open the delivery file 60. Incidentally, the contents of the reminding letter may be inserted in the text of the electronic mail.

Consequently, it is possible to exchange the delivery file 60 safely and surely via the data center between the delivery origin and the delivery destination.

Incidentally, at an instant when the downloading of the delivery file 60 from the server computer 1 to the delivery destination is completed, an electronic mail acknowledging the receipt may be automatically issued to the electronic mail address.

Further, a misdelivery preventing function may be provided, which interprets the applicant identification number or the like of the delivery destination in the delivery file 60 which is to be delivered and compares the applicant identification number with delivery destination information pre-managed by a master or the like, thereby preventing misdelivery. Here, this misdelivery preventing function will be described, by comparing it to a post-office box, assuming that the delivery file 60 to be delivered is, for example, file wrapper data or appended electronic data.

The misdelivery preventing function can be said to be a function of checking whether a sender is storing the delivery file 60 in a correct place by collating the identification number pre-set for a post-office box of a recipient and the identification number written in the delivery file 60 to be stored, thereby preventing the delivery file 60 from being stored in an incorrect place when the sender tries to store the delivery file 60 in the post-office box of the recipient.

Therefore, with the misdelivery preventing function, even if the security of a mail system is low, the delivery file 60 can be handled as if the electronic mail were being transmitted under a secure file sharing environment.

1. An intellectual property managing system, comprising:
a database in which common information on intellectual properties and individual information are stored, the common information being exchanged between at least two of a procedure-object organization, an enterprise, and an office, and the individual information being managed individually by the procedure-object organization, the enterprise, and the office;
a data synchronization master in which correspondence information is stored, the correspondence information being used in converting each item of pieces of the individual information, which are managed in the database separately on per enterprise basis, office basis, and procedure-object basis, into another;
job processing demanding units provided for the office, the enterprise, and the procedure-object organization respectively and issuing a demand in response to an instruction from a user; and
a job processing executing unit which executes relevant processing in response to the demand issued from any of the job processing demanding units, by reading relevant information from the database, and notifies a result of the processing to the demander while reflecting the information changed as a result of the processing, in the common information and the individual information in the database according to the correspondence information in the data synchronization master.

2. The intellectual property managing system according to claim 1,
wherein the job processing demanding units comprise:
user interface units provided for the office, the enterprise, and the procedure-object organization respectively and accepting an instruction for job execution which is input by the user; and
business logic units each issuing a job execution demand to the job processing executing unit according to the instruction input from the user interface unit, and outputting, to the user interface unit, a result of the job processing which is executed by the job processing executing unit in response to the job execution demand.

3. The intellectual property managing system according to claim 1,
wherein the job processing executing unit comprises an authenticating unit which performs user authentication by comparing input log-in information and authentication information registered in the database.

4. The intellectual property managing system according to claim 1,
wherein the job processing executing unit comprises an access control unit which, when the data in the database has been accessed by a user, restricts an access to the data from another user.

5. The intellectual property managing system according to claim 1,
wherein the job processing executing unit comprises a numbering unit which, triggered by an input of a case number assigned to a case by the enterprise or the office, assigns a reference number capable of uniquely specifying the case in the system, according to a predetermined numbering rule.

6. The intellectual property managing system according to claim 1,
wherein the job processing executing unit comprises a derivation unit which, when new information concerning a case is added to the database, calculates a time limit for processing the case, according to a legal term and a calendar stored in the database in advance.

7. The intellectual property managing system according to claim 1,
wherein the job processing executing unit, the database, and the data synchronization master are provided in a server computer connected to a network; and
wherein the job processing demanding units are provided in client computers connected to the network.

8. An intellectual property managing system in which a client computer of a delivery origin, a client computer of a delivery destination, and a server computer are connected to a network and the server computer transfers and delivers a delivery file transmitted from the client computer of the delivery origin to the client computer of the delivery destination,
wherein the server computer comprises a delivery manager which, after the delivery file received from the client computer of the delivery origin is delivered to the client computer of the delivery destination, monitors an opening state of the delivery file, and when the delivery file is opened in the client computer of the delivery destination within a predetermined period, automatically issues an electronic mail notifying that the delivery file is opened, to a pre-registered electronic mail address of the delivery origin, and when the predetermined period has passed, automatically issues a reminding electronic mail which urges to open the delivery file, to a pre-registered electronic mail address of the delivery destination.

9. An intellectual property managing method, comprising:
issuing, by any of job processing demanding units provided for an office, an enterprise, and a procedure-object organization respectively, a demand to a job processing executing unit in response to an instruction from a user;
executing, by the job processing executing unit, relevant processing in response to the demand issued from any of the job processing demanding units, by reading relevant information from a database in which common information on intellectual properties and individual information are stored, the common information being exchanged between at least two of the procedure-object organization, the enterprise, and the office, and the individual information being managed individually by the procedure-object organization, the enterprise, and the office; and
notifying, by the job processing executing unit, a result of the processing to the demander while reflecting the information changed as a result of the execution of the processing, in the common information and the individual information in the database according to correspondence information in a data synchronization master in which the correspondence information is stored, the correspondence information being used in converting each item of pieces of the individual information, which are managed in the database separately on per enterprise basis, office basis, and procedure-object organization basis, into another.

10. (canceled)
